(19) United States
(12) Patent Application Publication
(10) Pub. No.: US 2013/0160492 A1
(43) Pub. Date: Jun. 27, 2013

(54) POLISHED, HOT PRESSED, NET SHAPE CERAMICS

(71) Applicants: Guillermo R Villalobos, Springfield, VA (US); Bryan Sadowski, Falls Church, VA (US); Michael Hunt, Alexandria, VA (US); Robert E. Miklos, La Plata, MD (US); Shyam S. Bayya, Ashburn, VA (US); Woohong Kim, Lorton, VA (US); Jasbinder S. Sanghera, Ashburn, VA (US); Ishwar D. Aggarwal, Chapel Hill, NC (US)

(72) Inventors: Guillermo R Villalobos, Springfield, VA (US); Bryan Sadowski, Falls Church, VA (US); Michael Hunt, Alexandria, VA (US); Robert E. Miklos, La Plata, MD (US); Shyam S. Bayya, Ashburn, VA (US); Woohong Kim, Lorton, VA (US); Jasbinder S. Sanghera, Ashburn, VA (US); Ishwar D. Aggarwal, Chapel Hill, NC (US)

(21) Appl. No.: 13/335,990

(22) Filed: Dec. 23, 2011

(51) Int. Cl. C03B 19/09; B28B 3/00

(52) U.S. Cl. 65/17.3; 264/109

(57) ABSTRACT

A method for making a smooth ceramic including loading ceramic powder to be densified into a hot press die, placing one or more spacers with a polished surface between a hot press punch and the ceramic powder, placing the die and punch into a hot press and hot pressing the ceramic powder, and removing a smooth ceramic shape that requires no subsequent polishing or processing and has a surface roughness of 5 nm RMS or better. The smooth ceramic shape may be transparent, and it may be spinel, magnesia, yttria, lutetia, scandia, YAG, any composites thereof, or any of their rare earth doped compounds. Also disclosed is the related smooth ceramic made by this process.

### FIELD OF THE INVENTION

The present invention relates generally to ceramics and more specifically to hot pressed polished ceramics.

### BACKGROUND OF THE INVENTION

Technical ceramics, such as spinel, have many uses. Dense magnesium aluminate spinel (MgAl₂O₄) is hard, strong, and transparent from 0.2 to 5.5 μm. Its mechanical properties are several times greater than that of glass and make it a leading candidate for use as a transparent armor, dome, and window material. It can also be used as a stronger and thinner window for laptop computers, cell phones, automotive glassing and headlamps, aerospace windshields, bar code readers, transparent armor for personnel protection, etc.

Spinel originates as a loose powder that must be densified into a monolithic shape with the application of heat and pressure i.e. hot pressing. Hot pressing of spinel leads to a rough surface that must be lapped, ground, and polished for it to become a usable transparent material. The various steps needed to obtain a polished appearance generally account for over half of the manufacturing cost.

FIG. 1 shows a traditional hot press process schematic. Hot pressing is the act of consolidating powder into a dense shape through the application of heat and pressure. The sample powder being densified 10 is placed in a die 20 that can be made of graphite, ceramic, or metals and their alloys. Pressure is applied through punches 30 also made of graphite, ceramic or metal/alloys. The die 20 and punch 30 surfaces contacting the powders having a lining 50 to prevent reactions that may damage the die 20 or unfavorably affect the powder 10 or dense shape 70. Typical lining materials 50 are graphite foil or boron nitride.

The punch 30 and die 20 surfaces are initially machine finished to a flatness of 0.005 inch, but they are not mirror finished. Due to the high temperatures and pressures involved in hot press runs, chipping, scratching, and roughening of the punch 30 and die 20 surfaces during use is normal. The lining material 50 extends punch 30 life, but does not prevent the normal wear and tear.

Two reasons for the rough surface 60 seen on hot pressed materials include the transfer of the punch 30 surface to the finished part and the pliability of the lining 50 material. As pressure is applied during the hot pressing operation, the layer of powder 10 next to the lining material 50 is pressed into the lining material 50. The powder particles 10 are eventually densified into the ceramic spinel shape 70, but the surface of the ceramic in contact with the lining material 50 retains roughness of the initial powder.

### BRIEF SUMMARY OF THE INVENTION

The aforementioned problems are overcome in the present invention which provides a method for making a smooth ceramic including loading ceramic powder to be densified into a hot press die, placing one or more spacers with a polished surface between a hot press punch and the ceramic powder, placing the die and punch into a hot press and hot pressing the ceramic powder, and removing a smooth ceramic shape that requires no subsequent polishing or processing and has a surface roughness of 5 nm RMS (root-mean-square) or better. The smooth ceramic shape may be transparent, and it may be spinel, magnesia, yttria, lutetia, scandia, yttrium aluminum garnet (YAG), any composites thereof, or any of their rare earth doped compounds. Also disclosed is the related smooth ceramic made by this process.

Since it is not practical to polish the punch surface before each use, in one embodiment of the present invention, the pliable punch lining material is replaced with a structural layer that can be polished to a mirror finish. This material can be separate from the die and punch surfaces so that it is easily replaceable if it becomes damaged, and it is sufficiently cheap that it does not grossly impact the hot pressing cost. Ideally, the structural layer is harder than the ceramic so that it does not scratch and damage. If the structural material is hard enough, it can be an integral part of the punch.

A polished surface straight from the hot press procedure significantly reduces the cost of producing ceramic products because grinding, polishing, and other processing steps are not needed. This enables net-shaped fabrication of polished spinel parts and other ceramics such as yttria, lutetia, scandia, YAG, as well as their rare earth doped compounds used for making lasers.

These and other features and advantages of the invention, as well as the invention itself, will become better understood by reference to the following detailed description, appended claims, and accompanying drawings.

### BRIEF DESCRIPTION OF THE DRAWINGS

FIG. 1 is a schematic of the traditional hot press process using high quality graphite foil (grafoil) to protect powder from interaction with the graphite die resulting in a ceramic with a rough outer surface that has to be ground off.

FIG. 2 is a schematic of a hot press process using a template material with a polished surface resulting in a ceramic with a smooth surface needing no subsequent polishing.

FIG. 3 shows two perspectives of samples after hot pressing highlighting (i) graphite foil stuck on the surface of a sample made by the traditional process disclosed in prior art, (ii) the rough surface after peeling off the graphite foil of a sample made by the traditional process disclosed in prior art, and (iii) the smooth, transparent surface of a sample made by the process of the present invention.

FIG. 4 shows graphs comparing the absorption spectrum of (a) the traditional hot press process with (b) the hot press process of the present invention.

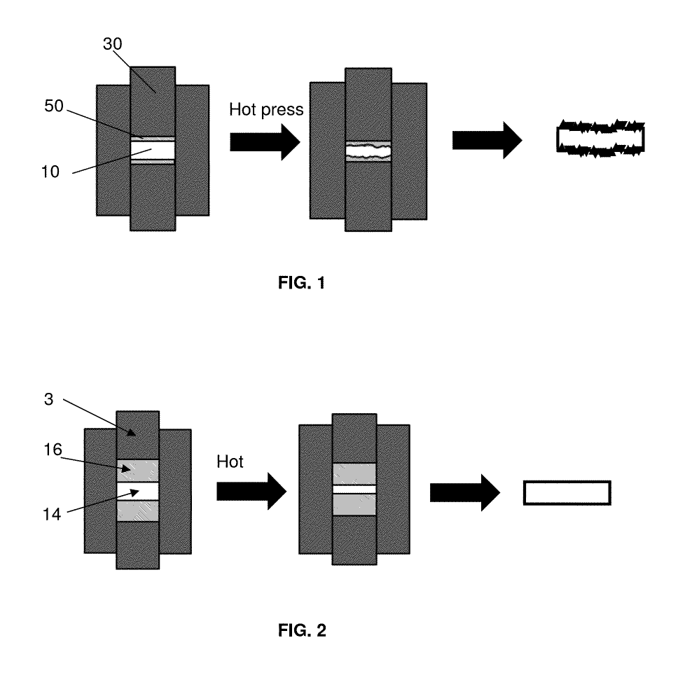

### DETAILED DESCRIPTION OF THE INVENTION

The present invention is directed towards a process for making a smooth ceramic shape that emerges from a hot press die in a polished condition (having a surface roughness of 5 nm RMS or better). The ceramic shape may be transparent. For example, magnesium aluminum spinel is a polycrystalline ceramic that is smooth and transparent after hot pressing by the process of the present invention.

As shown in FIG. 2, a polished spacer 55 is placed between the hot press punch 30 and the powder 10 to be densified. The spacer material 55 is hard enough to prevent deformation from the powder being densified and is also non-reactive with the powder. Examples of suitable materials include hard refractory ceramics such as carbides, borides, silicides, nitrides, diamond as well as vitreous carbon. The structural material could be made from their mixtures, laminates or coated substrates. The hard spacer material 55 prevents the powder 10 from becoming embedded and provides a polished surface for the powder 10 during densification. The structural spacer material 55 easily separates from the densified ceramic thereby leaving its smooth surface 65 imprinted on the ceramic shape 70. This leads to significant savings of cost and time to produce a net-shaped smooth spinel part.

Many ceramics may be used in this process. Some examples include spinel, magnesia, yttria, lutetia, scandia, yttrium aluminum garnet (YAG), any composites thereof, and any of their rare earth doped compounds commonly used for making lasers and scintillators. The surface quality of the ceramics is limited by the quality of the structural material's surface. Consequently, the surface quality can be very smooth, being better than 4600 nm, and more typically better than 250 nm, and even more typically better than 5 nm.

Additionally, the process of the present invention may be used on glass or glass/ceramic composites. For example, germanate glass or a germanate glass/spinel composite.

The polished spacer material does not have to be flat. It can be polished into simple or compound shapes and curves suitable for making, as example but not inclusive, lenses, cavities, stepped structures, etc.

In one embodiment of the present invention, no sintering aid or a reduced amount of sintering aid is used. Using less or no sintering aid can further reduce processing costs of the ceramic.

### EXAMPLES

The examples below highlight the use of vitreous carbon and WC as structural materials during hot pressing of spinel ceramic to produce a mirror-like surface finish. Additionally, example 3 highlights the fabrication of spinel ceramic without adding sintering aid which could further simplify the process to make hot pressed spinel ceramic.

### Example 1

Approximately 10 g of spinel powder with about 0.5% sintering aid (LiF) was loaded into a standard hot press die. Polished vitreous carbon spacers were inserted directly in contact with the powder, specifically above and below it. Graphite foil was placed between the vitreous carbon and the graphite punches to prevent sticking. The graphite foil was not in contact with the powder since the powder was directly in contact with the vitreous carbon. The die and punch set was placed in a hot press and run in the traditional manner. In this case, the hot press was heated to 1200° C. and left there for 30 minutes to allow evaporation of the sintering aid. This was followed by heating to 1600° C. at which point about 2500 psi load was applied for 2 hours. The load was then removed and the furnace cooled down to room temperature. After hot pressing the parts were disassembled and the ceramic shape fell easily away from the vitreous carbon spacers. Examination revealed that the surface resembled a polished finish despite the fact it had not been polished, and furthermore, the sample exhibited better transmission. Also, the dimensions were of the actual final product, so they did not need to be further processed.

### Example 2

The same procedure was used as in example 1, except that the structural material used was tungsten carbide (WC). Similar results were obtained, whereby the surface finish resembled a well polished spinel part.

### Example 3

The same procedure was used as in example 1, but no sintering aid was added. The hot pressed spinel ceramic also exhibited a minor-like surface finish as well as no signs of reduction. In other words, the sample was clear and transparent. Typical processing of sintering aid-free powder without the structural material leads to partial reduction (oxygen deficient) of spinel causing it to look grey or black. Therefore, it appears that the structural material also protects the powder from reducing gases present during the hot pressing process.

### Example 4

This sample was made with the same procedure as in Example 1 except that the vitreous carbon plates were not used. Consequently, the spinel powder was in direct contact with the graphite foil. This represents the traditional process. After hot pressing, the graphite foil stuck to the spinel ceramic and had to be removed by either grinding or peeling it away.

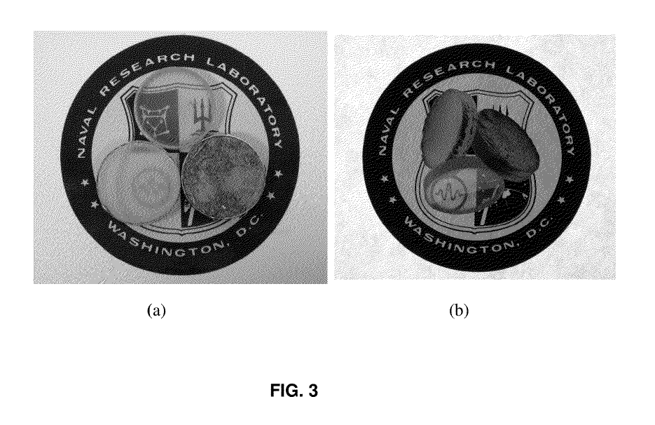

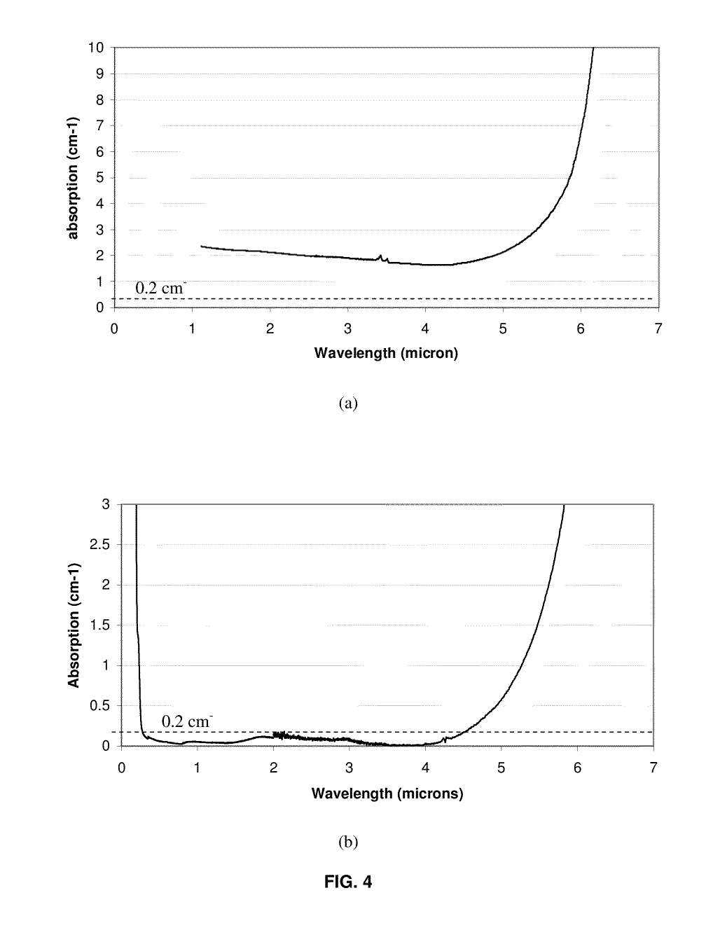

FIG. 3 shows pictures of spinel ceramic samples from this traditional process as soon as they are removed from the hot press highlighting (i) the graphite foil stuck to the surface and (ii) the rough surface after the graphite foil has been peeled away. Also shown for comparison is (iii) a sample made by the present invention, highlighting its superior surface quality and better transmission. FIG. 4 shows graphs comparing the absorption spectrum of (a) the traditional hot press process with (b) the hot press process of the present invention.

### Example 5

This sample was made with the same procedure as in Example 1 except that the vitreous carbon plates were ground and polished into curved lens shapes. After hot pressing, the ceramic, due to its shape, acted as a lens without any further shaping or polishing.

The above descriptions are those of the preferred embodiments of the invention. Various modifications and variations are possible in light of the above teachings without departing from the spirit and broader aspects of the invention. It is therefore to be understood that the claimed invention may be practiced otherwise than as specifically described. Any references to claim elements in the singular, for example, using the articles “a,” “an,” “the,” or “said,” are not to be construed as limiting the element to the singular.

What is claimed as new and desired to be protected by Letters Patent of the United States is:

1. A method for making a smooth ceramic, comprising:
loading ceramic powder to be densified into a hot press die;
placing one or more spacers with a polished surface between a hot press punch and the ceramic powder;
placing the die and punch into a hot press and hot pressing the ceramic powder; and
after hot pressing, removing a smooth ceramic shape that requires no subsequent polishing or processing and has a surface roughness of 5 nm RMS or better.

2. The method of claim 1, wherein the smooth ceramic shape is transparent.

3. The method of claim 1, wherein the smooth ceramic shape is not transparent.

4. The method of claim 1, wherein the ceramic is spinel, magnesia, yttria, lutetia, scandia, YAG, any composites thereof, or any of their rare earth doped compounds.

5. The method of claim 1, wherein the ceramic is magnesium aluminum spinel.

6. The method of claim 1, wherein the ceramic is a glass/ceramic composite.

7. The method of claim 1, wherein the spacer comprises a carbide, boride, silicide, nitride, diamond, vitreous carbon, or any combination thereof.

8. The method of claim 1, wherein the spacer is not flat.

9. The method of claim 8, wherein the smooth ceramic shape is a lens.

10. The method of claim 1, wherein hot pressing is done without a sintering aid.

11. A smooth ceramic made by a process comprising the steps of:
loading ceramic powder to be densified into a hot press die;
placing one or more spacers with a polished surface between a hot press punch and the ceramic powder;
placing the die and punch into a hot press and hot pressing the ceramic powder; and
after hot pressing, removing a smooth ceramic shape that requires no subsequent polishing or processing and has a surface roughness of 5 nm RMS or better.

12. The ceramic of claim 11, wherein the smooth ceramic shape is transparent.

13. The ceramic of claim 11, wherein the smooth ceramic shape is not transparent.

14. The ceramic of claim 11, wherein the ceramic is spinel, yttria, lutetia, scandia, YAG, or any of their rare earth doped compounds.

15. The ceramic of claim 11, wherein the ceramic is magnesium aluminum spinel.

16. The ceramic of claim 11, wherein the ceramic is a glass/ceramic composite.

17. The ceramic of claim 11, wherein the spacer comprises a carbide, boride, silicide, nitride, diamond, vitreous carbon, or any combination thereof.

18. The ceramic of claim 11, wherein the spacer is not flat.

19. The ceramic of claim 18, wherein the smooth ceramic shape is a lens.

20. The ceramic of claim 11, wherein hot pressing is done without a sintering aid.

21. A method for making a smooth glass, comprising:
loading glass powder to be densified into a hot press die;
placing one or more spacers with a polished surface between a hot press punch and the glass powder;
placing the die and punch into a hot press and hot pressing the glass powder; and
after hot pressing, removing a smooth glass shape that requires no subsequent polishing or processing and has a surface roughness of 5 nm RMS or better.
